(19) United States
(12) Patent Application Publication
(10) Pub. No.: US 2013/0254789 A1
(43) Pub. Date: Sep. 26, 2013

(54) TELEVISION RECEIVER AND CHANNEL SELECTION METHOD

(71) Applicant: Akira Okumura, Tokyo (JP)

(72) Inventor: Akira Okumura, Tokyo (JP)

(21) Appl. No.: 13/601,672

(22) Filed: Aug. 31, 2012

(30) Foreign Application Priority Data
Mar. 23, 2012 (JP) JP2012-067234

(51) Int. Cl. H04N 21/442

(52) U.S. Cl. 725/14

(57) ABSTRACT

At power-on of a television receiver, a selection part selects a channel most likely to be selected by a user among all channels over which the television receiver is capable of receiving programs, based on pieces of program history information of program history databases.

### BACKGROUND OF THE INVENTION

1. Field of the Invention

The present invention relates to a television receiver that performs a process for selecting a channel and a channel selection method.

2. Description of the Background Art

Recent digitalization of television broadcasting leads to various broadcast waves such as a ground wave, and those for broadcasting satellite (BS) and communication satellite (CS) as well as a large number of programs (content). A user has to select a type of a broadcast wave and a channel (channel selection) from such an enormous amount of broadcast content after turning on the power of a television receiver by a power-on switch or a remote controller for viewing a desired program. That is, a series of operations from turning-on of the power of the television receiver to viewing of a desired program is becoming complex.

Further, there are channels not less than the number of ten keys provided on a remote controller or the like, and thus, a user may make a selection only by pressing a multiple-digit number with the ten keys.

Meanwhile, in a case where a user does not remember the broadcast wave type or channel number of desired content, the user is required to make a selection by referring to a program guide in a newspaper or magazine, on the Internet or the like in advance, or activating an electronic program guide (EPG) and then searching for a desired program.

In view of the above, there is devised the method of alleviating the inconvenience of the above-mentioned series of operations from turning-on of the power of a television receiver to selection of a broadcast wave and channel selection for viewing a program, so that a user selects a program to watch by intuition without consideration of program search or selection in a short period of time.

For example, Japanese Patent Application Laid-Open No. 2000-201303 discloses the technology (hereinafter, also referred to as conventional technology A) of alleviating a burden in program selection by judging a taste of a user from a past history or keywords and providing the user with program information. Also, Japanese Patent Application Laid-Open No. 2000-341596 discloses the technology (hereinafter, also referred to as conventional technology B) of providing a virtual program guide from the taste of the user, to thereby improve the ease-of-use of program selection by a user.

That is, in the conventional technologies A and B, a list of content tailored for the taste of a user is displayed or recommended, to thereby provide the user with information for simplifying an act of selecting a channel by the user.

Although there are the technology of providing a user with new information for program selection, the technology of simplifying information to be provided, and other technology as the technology of improving channel selection, unfortunately, the user cannot avoid the inconvenience of recognizing the information and then selecting a channel. Therefore, in the conventional technologies A and B, a user cannot reach a desired channel (program) by intuition without consideration of program search or program selection.

### SUMMARY OF THE INVENTION

An object of the present invention is to provide a television receiver and the like capable of allowing a user to promptly select a desired channel.

A television receiver according to an aspect of the present invention displays a program consisting of video images. The television receiver includes: a history recording part recording pieces of program history information respectively indicating information of a plurality of programs in a past predetermined period, the plurality of programs having been displayed by the television receiver; and a selection part selecting, at power-on of the television receiver, a channel most likely to be selected by a user among all channels over which the television receiver is allowed to receive a program, based on the pieces of program history information.

According to the present invention, the selection part selects, at power-on of the television receiver, a channel most likely to be selected by a user among channels over which the television receiver is capable of receiving a program.

Accordingly, at power-on of the television receiver, the channel for displaying a program most likely to be selected by a user is selected without awareness by the user. This enables to promptly select a channel desired by the user.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configurations of a television receiver and a remote controller according to a preferred embodiment of the present invention;

FIG. 2 is a table showing an example of a program history database;

FIG. 3 is a flowchart of a history information recording process;

FIG. 4 is a flowchart of a selection process; and

FIG. 5 is a flowchart of a selection process A.

### DESCRIPTION OF THE PREFERRED EMBODIMENT

Hereinbelow, an embodiment of the present invention is described with reference to drawings. In the following description, like references denote similar elements, which holds true for the names and functions thereof. Thus, detailed descriptions thereof are omitted at times.

### First Preferred Embodiment

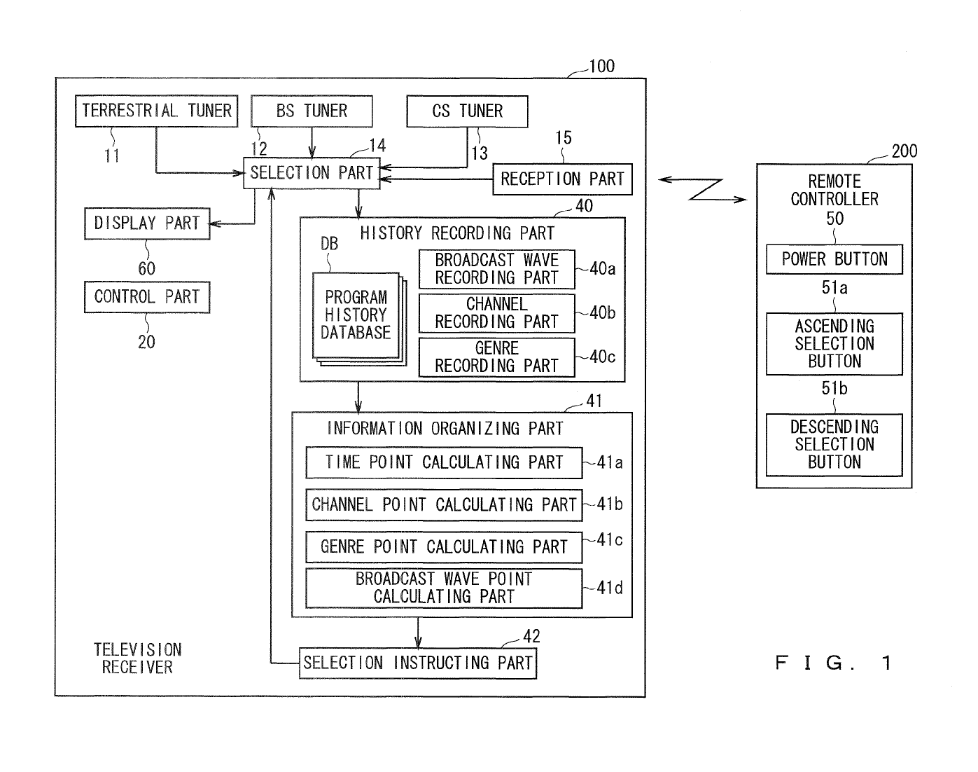

FIG. 1 is a block diagram showing the configurations of a television receiver 100 and a remote controller 200 according to this preferred embodiment.

The television receiver 100 has a normal mode and a standby mode as operation modes.

The normal mode is a mode in which the main power of the television receiver 100 is turned on and the television receiver 100 is capable of displaying a program consisting of video images. Herein, the program refers to video content expressed in the form of video image.

The standby mode is a mode in which the main power of the television receiver 100 is turned off and the television receiver 100 is incapable of displaying a program. The television receiver 100 in the standby mode is capable of receiving a signal from the remote controller 200.

The television receiver 100 is provided with a power button (not shown), channel buttons (not shown), and the like. The power button is a button that is pressed down by a user to switch the operation mode of the television receiver 100.

As a result of the operation of pressing down the power button by a user, the operation mode of the television receiver 100 is changed from the standby mode to the normal mode or from the normal mode to the standby mode.

Specific channels are assigned to the channel buttons. The channel button is a button that is pressed down by a user to cause the television receiver 100 to display a program of the specific channel.

The remote controller 200 is a device for controlling the television receiver 100. That is, in a case where a user performs an operation on the remote controller 200, the remote controller 200 sends a signal corresponding to the operation to the television receiver 100 using infrared rays or the like. As a result, the television receiver 100 is controlled by the remote controller 200 operated by the user.

The remote controller 200 includes a power button 50, an ascending selection button 51a, and a descending selection button 51b.

The power button 50 is a button that is pressed down by a user to output a power signal. The power signal is a signal for switching the operation mode of the television receiver 100. Specifically, in a case where the operation mode of the television receiver 100 is the standby mode, the power signal serves to switch the operation mode of the television receiver 100 from the standby mode to the normal mode. Also, the power signal serves to switch the operation mode of the television receiver 100 from the normal mode to the standby mode.

The ascending selection button 51a and the descending selection button 51b are described below in detail, which are buttons pressed down by a user to select another channel different from a currently selected channel (channel selection). The ascending selection button 51a is a button that is pressed down to cause the remote controller 200 to output an ascending selection signal for switching channels in an ascending order. The descending selection button 51b is a button that is pressed down to cause the remote controller 200 to output a descending selection signal for switching channels in a descending order.

Hereinbelow, the signal for selecting a channel is also referred to as a channel selection signal. Each of the ascending selection signal and the descending selection signal is the channel selection signal.

The remote controller 200 serves as a program selection device that performs the process for selecting a program when the ascending selection button 51a or the descending selection button 51b is operated (pressed down).

The remote controller 200 further includes ten keys (not shown), broadcast wave buttons (not shown), a program guide button (not shown), a program selection button (not shown), and the like. The ten keys, broadcast wave buttons, program guide button, and program selection button are generally used ones, which are briefly described below.

The ten keys are keys that are pressed down by a user to cause the remote controller 200 to output a channel selection signal. The broadcast wave buttons are buttons for selecting broadcast waves such as a ground wave, BS wave, and CS wave. The broadcast wave buttons include a ground wave button, a BS button, and a CS button.

The ground wave button is a button that is pressed down to cause the remote controller 200 to output a ground wave selection signal indicating that a ground wave has been selected. The BS button is a button that is pressed down to cause the remote controller 200 to output a BS wave selection signal indicating that a BS wave has been selected. The CS button is a button that is pressed down to cause the remote controller 200 to output a CS wave selection signal indicating that a CS wave has been selected. Hereinbelow, each of the ground wave selection signal, BS wave selection signal, and CS wave selection signal is referred to as a broadcast wave selection signal.

Various signals (for example, a channel selection signal) output from the remote controller 200 are instructions by a user, which are in accordance with the operation of the user.

The program guide button serves to call up a program guide. The program selection button serves to select a program.

Next, the television receiver 100 is described.

The television receiver 100 includes a plurality of tuners. The television receiver 100 according to this preferred embodiment includes a terrestrial tuner 11, a BS tuner 12, and a CS tuner 13 as an example. The television receiver 100 further includes a selection part 14, a reception part 15, a control part 20, a history recording part 40, an information organizing part 41, a selection instructing part 42, and a display part 60.

The control part 20 controls the selection part 14, the history recording part 40, the information organizing part 41, the selection instructing part 42, and the display part 60.

The terrestrial tuner 11 demodulates a terrestrial digital broadcast wave received from an antenna (not shown) and obtains a terrestrial digital signal as a broadcast wave signal. The terrestrial digital signal includes programs (video content) respectively corresponding to a plurality of channels corresponding to the ground wave. The terrestrial tuner 11 sends the terrestrial digital signal to the selection part 14.

The BS tuner 12 demodulates a BS digital broadcast wave received from the antenna (not shown) and obtains a BS digital signal as a broadcast wave signal. The BS digital signal includes programs (video content) respectively corresponding to a plurality of channels corresponding to the BS wave. The BS tuner 12 sends the BS digital signal to the selection part 14.

The CS tuner 13 demodulates a CS digital broadcast wave received from the antenna (not shown) and obtains a CS digital signal as a broadcast wave signal. The CS digital signal includes programs (video content) respectively corresponding to a plurality of channels corresponding to the CS wave. The CS tuner 13 sends the CS digital signal to the selection part 14.

Hereinbelow, each of the terrestrial tuner 11, the BS tuner 12, and the CS tuner 13 is merely referred to as a reception tuner as well.

The reception part 15 serves to receive a signal through radio communication or the like.

In a case where the reception part 15 receives a broadcast wave selection signal, the selection part 14 selects a broadcast wave signal corresponding to a broadcast wave indicated by the received broadcast wave selection signal. Also, in a case where the reception part 15 receives a channel selection signal, the selection part 14 selects one channel (channel selection) specified by the received channel selection signal from a plurality of channels indicated by the selected broadcast wave signal.

In a case where the operation of pressing down a channel button is performed by a user, the selection part 14 selects a channel (channel selection) assigned to the channel button.

The display part 60 is a display on which characters, images (video images), and the like are displayed. The display part 60 displays a program (video content) of the channel selected by the selection part 14. As an example, the display part 60 displays a program of a channel selected by the selection part 14 upon reception of the channel selection signal as an instruction from a user.

Hereinbelow, the channel selected by the selection part 14 is also referred to as a selected channel. The program of the channel selected by the selection part 14 upon reception of a channel selection signal or the operation of pressing down a channel button is also referred to as a selected program. Hereinbelow, the reception of a channel selection signal or the operation of pressing down a channel button is also referred to as a selection instruction.

Although detailed description is given below, the history recording part 40 records the information of the program displayed on the display part 60 (that is, program viewed by a user) in units of broadcast waves, in units of channels, and in units of genres of programs. The broadcast waves include a ground wave, a BS wave, a CS wave, and the like. The genres of programs are classified into, for example, news, drama, music, sports, animation, program for children, variety, and information. Indexes regarding the time frame in which a program has been displayed, such as day and time, are associated with the information of the program.

More specifically, the history recording part 40 records the information of the selected program, which is displayed on the display part 60 (of the television receiver 100), in the program history database as program history information every time the selection part 14 selects a channel in response to the selection instruction. The program history information is recorded a plurality of times, so that the program history database DB showing a plurality of pieces of program history information is configured.

Although detailed description is given below, the information organizing part 41 associates (assigns) a point showing a larger value with (to) the channel favored more strongly by the user.

More specifically, the information organizing part 41 calculates a point per channel using the information of a program shown in each piece of program history information such that among all channels over which programs can be received, a channel more likely to be selected by the user at least at power-on shows a larger value.

That is, the information organizing part 41 is a point calculating part that calculates points for the all channels over which all reception tuners can receive programs, using the program history database DB. The point is calculated using a weighting factor in units of channels, in units of broadcast waves, and in units of genres in the current time frame in which programs are displayed.

The information organizing part 41 respectively associates (assigns) the calculated points with (to) the channels. Also, the information organizing part 41 sorts the channels over which the programs can be received currently, which correspond to the points, in a descending order of values of the points.

The information organizing part 41 includes a time point calculating part 41a, a channel point calculating part 41b, a genre point calculating part 41c, and a broadcast wave point calculating part 41d.

Although detailed description is given below, the time point calculating part 41a calculates a point in consideration of time. Each of the channel point calculating part 41b, the genre point calculating part 41c, and the broadcast wave point calculating part 41d calculates a point without consideration of time, which is described below in detail.

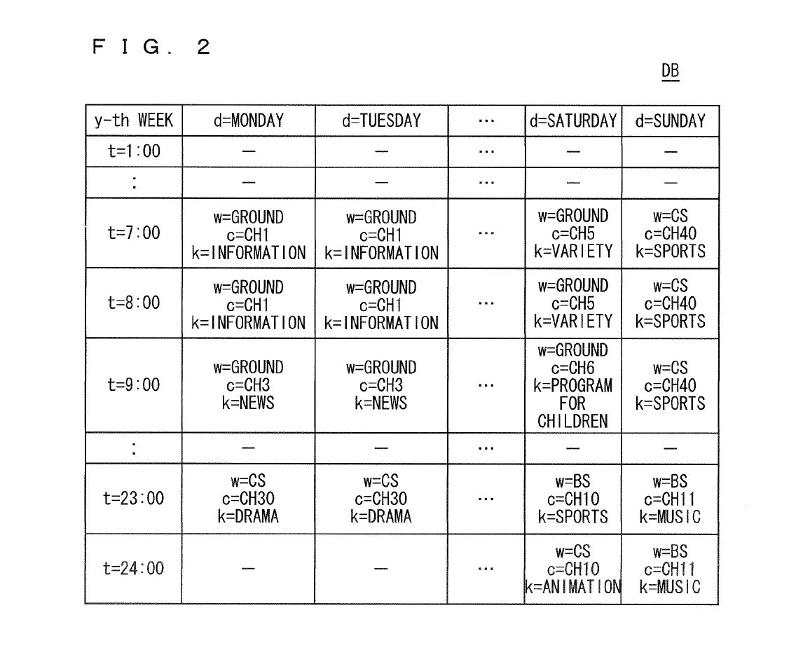

FIG. 2 is a table showing an example of the program history database DB. The program history database DB shows a plurality of pieces of program history information for a week. Hereinbelow, the program history database DB is merely referred to as DB as well.

In FIG. 2, “y (y is a natural number)-th week” indicates that the program history information shown in the program history database DB is the y-th week information, “d” indicates a day, and “t” indicates a time on an hour-by-hour basis. In FIG. 2, the information of each cell specified by a column of day and a row of time is the program history information.

The program history database DB is a database showing the information of the structure of a three-by-three array, which corresponds to each time in a week. Specifically, each piece of program history information shown in the program history database DB corresponds to the information of the structure of a three-by-three array.

In FIG. 2, the information of the structure of a three-by-three array is represented as (week y, day d, time t)=(broadcast wave w, channel c, program genre k).

Here, the broadcast wave w is indicated by any of “ground”, “BS”, and “CS”, where “ground”, “BS”, and “CS” represent a ground wave, a BS wave, and a CS wave, respectively.

The channel c is represented as CHn (n is a natural number). For example, a channel CH5 represents a channel numbered 5.

The program genre k represents a genre of a program. The genres classified into, for example, news, drama, music, sports, animation, program for children, variety, and information. For example, the program whose genre is “information” is a program that provides various pieces of information (such as information for health).

For example, here, the display part 60 displays the selected program selected by the selection part 14 at seven o'clock in the morning on the y-th week Monday. As an example, the selected program is a program on a ground wave, in which the number of a channel for displaying the selected program is one and the genre of the selected program is “information”.

In this case, the program history information that DB (y, d: month, t: 7)=(w=ground, c=CH1, k=information) has been registered in the y-th week program history database DB of FIG. 2. Specifically, the information (program history information) of a cell specified by a column “Monday” and a row “t=7:00” represents “w=ground, c=CH1, k=information”.

Also, for example, the display part 60 displays the selected program selected by the selection part 14 at 23 o'clock on the y-th week Sunday. As an example, the selected program is a program on a BS wave, in which the number of a channel for displaying the selected program is 11 and the genre of the selected program is “music”.

In this case, the program history information that DB (y, d: day, t: 23)=(w=BS, c=CH11, k=music) has been registered in the y-th week program history database DB of FIG. 2.

Next, the process for recording information in the program history database (hereinbelow, also referred to as history information recording process) is described. The history information recording process is performed as required independently of another process. The history information recording process is performed every time the display part 60 displays the selected program. Although detailed description is given below, the history information recording process is a process in which the history recording part 40 records the program history information indicating the information of each of a plurality of programs in a past predetermined period, which have been displayed by the television receiver 100.

Referring again to FIG. 1, the history recording part 40 includes a broadcast wave recording part 40a, a channel recording part 40b, and a genre recording part 40c.

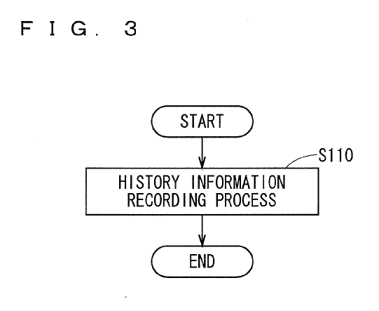

In the history information recording process (S 110) of FIG. 3, the broadcast wave recording part 40a, the channel recording part 40b, and the genre recording part 40c each record information described below in the program history database DB per time on an hour-by-hour basis.

The broadcast wave recording part 40a, the channel recording part 40b, and the genre recording part 40c each record, for example, the information described below in the program history database DB every time an hour elapses. That is, the unit of t in FIG. 2 is one hour. Note that the unit of t is not limited to one hour but may be, for example, 30 minutes.

For example, here, the reception part 15 received a channel selection signal (instruction from a user) through the operation of the remote controller 200 by the user. Then, in accordance with the channel selection signal, the display part 60 of the television receiver 100 has displayed the selected program on a ground wave for 30 minutes from 7 o'clock in the morning to 8 o'clock in the morning. In this case, the broadcast wave recording part 40a, the channel recording part 40b, and the genre recording part 40c each record the information described below in the row of the time “t=7:00” of the program history database DB at eight o'clock in the morning.

Detailed description is given below.

In the history information recording process, the broadcast wave recording part 40a records the type of the broadcast wave per time on an hour-by-hour basis.

Specifically, the broadcast wave recording part 40a records, in the program history database DB, any of “ground”, “BS”, and “CS” described above that represents the broadcast wave w for providing the selected program displayed by the display part 60.

For example, here, the reception part 15 received a channel selection signal (instruction from a user) through the operation of the remote controller 200 by the user. Then, in accordance with the channel selection signal, the display part 60 of the television receiver 100 has displayed the selected program on a CS wave for 30 minutes from 7 o'clock in the morning to 8 o'clock in the morning on the y-th week Sunday. In this case, the broadcast wave recording part 40a describes (records) “w=CS” in the information (program history information) of the cell specified by the column “Sunday” and the row “t=7:00” in the program history database DB of FIG. 2.

Also, in the history information recording process, the channel recording part 40b records channel information per time on an hour-by-hour basis. Specifically, the channel recording part 40b records, in the program history database DB, the channel information for displaying a selected program displayed by the display part 60.

For example, here, the reception part 15 received a channel selection signal (instruction from a user) through the operation of the remote controller 200 by the user. Then, in accordance with the channel selection signal, the display part 60 of the television receiver 100 has displayed the selected program of a channel numbered one for 30 minutes from 7 o'clock in the morning to 8 o'clock in the morning on the y-th week Monday. In this case, the channel recording part 40b describes (records) “c=CH1” in the information (program history information) of the cell specified by the column “Monday” and the row “t=7:00” in the program history database DB of FIG. 2.

The process of recording channel information is not limited to the process performed in response to the reception of a channel selection signal from the remote controller 200. The process of recording channel information may be performed in a case where the user performs the above-mentioned operation of pressing down a channel button.

In the history information recording process, the genre recording part 40c records genre information per time on an hour-by-hour basis. Specifically, the genre recording part 40c records genre information of the selected program displayed on the display part 60 in the program history database DB.

For example, here, the reception part 15 received a channel selection signal (instruction from a user) through the operation of the remote controller 200 by the user. Then, in accordance with the channel selection signal, the display part 60 of the television receiver 100 has displayed the selected program whose genre is “sports” for 30 minutes from 7 o'clock in the morning to 8 o'clock in the morning on the y-th week Sunday. In this case, the genre recording part 40c describes (records) “k=sports” in the information (program history information) of the cell specified by the column “Sunday” and the row “t=7:00” in the program history database DB of FIG. 2.

From the above, the history information recording process is the process in which the history recording part 40 records program history information indicating information of each of a plurality of programs in the past predetermined period that have been displayed by the television receiver 100.

As described above, the broadcast wave recording part 40a, the channel recording part 40b, and the genre recording part 40c each record information in the program history database DB in the history information recording process (S 110), so that the information of the program selected through the operation of the remote controller 200 by the user is recorded. That is, the information of a program favored by the user is recorded in the program history database DB. In other words, information of the program strongly favored by the user is recorded in the program history database DB.

The television receiver 100 does not necessarily display the same program in a certain unit time. That is, a user does not necessarily view the same program in a certain unit time. In other words, a plurality of programs are displayed in a unit time in some cases. In such cases, the broadcast wave recording part 40a, the channel recording part 40b, and the genre recording part 40c may each record only the information of the program which has been displayed (viewed) longest in the above-mentioned one hour, per time on an hour-by-hour basis.

The program scheduling and the taste of a user change in a certain cycle at times. Therefore, y representing a certain week may be used as a variable showing a period for retaining period data (hereinbelow, also referred to as a retention period) in accordance with the storage capacity of the history recording part 40. The retention period is, for example, 12 weeks, 24 weeks, or 48 weeks. In this case, pieces of information of the programs beyond the retention period may be successively erased or overwritten.

The portion of the program history database DB, which corresponds to the time when the user did not turn on the main power of the television receiver 100 and any program has not been displayed (viewed), may be blank.

Next, the process for selecting a program (channel) favored by a user (hereinbelow, also referred to as selection process) is described. The selection process is performed at power-on of the television receiver 100 in a standby mode. “At power-on” refers to a period in which the operation mode of the television receiver 100 is shifted from the standby mode to the normal mode.

The power of the television receiver 100 is turned on through the operation of pressing down the power button 50 of the remote controller 200 by a user. The power of the television receiver 100 may be turned on through the operation of pressing down a power button provided in the television receiver 100 by a user.

The program history databases DB for past several weeks have been registered in the history recording part 40 through the history information recording process described above. Here, the present date and time is a time T on the Y-th day D. Note that the time T is represented as time on an hour-by-hour basis without consideration given to minutes. For example, “7:20 in the morning” is taken as the time at seven o'clock.

Hereinbelow, the channels over which the above-mentioned reception tuners (terrestrial tuner 11, BS tuner 12, and CS tuner 13) are currently capable of receiving programs are also referred to as reception-enabled channels.

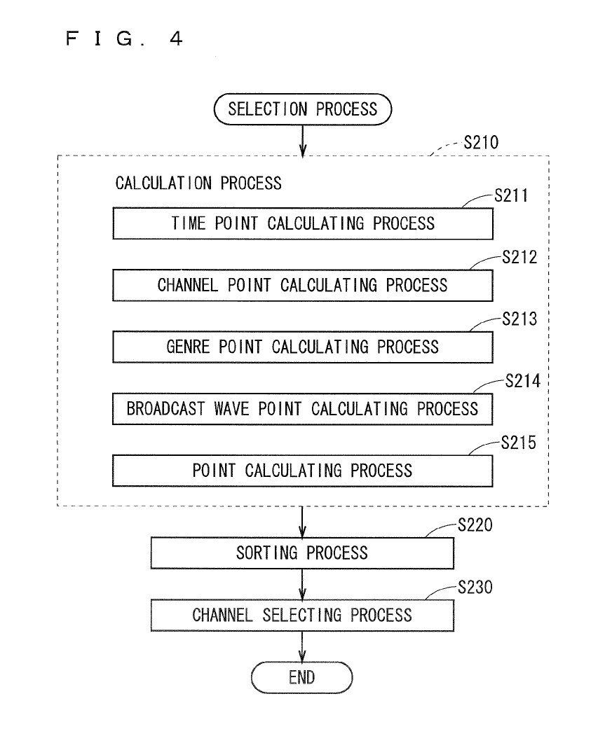

FIG. 4 is a flowchart of the selection process.

A calculation process is performed in Step S210. The calculation process is a process for calculating a point for organizing information.

The calculation process includes a time point calculating process (S211), a channel point calculating process (S212), a genre point calculating process (S213), a broadcast wave point calculating process (S214), and a point calculating process (S215).

The time point calculating process, the channel point calculating process, the genre point calculating process, and the broadcast wave point calculating process are performed in parallel with and independently of each other. The point calculating process is performed after the end of the time point calculating process, channel point calculating process, genre point calculating process, and broadcast wave point calculating process.

The execution order of the processes included in the calculation process is not limited to the above, and may be executed in the order of, for example, the time point calculating process, the channel point calculating process, the genre point calculating process, and the broadcast wave point calculating process.

In the time point calculating process of Step S211, the time point calculating part 41a associates a point showing the largest value with a channel for displaying a program most likely to be viewed (selected) by a user at the current time among the all reception-enabled channels.

More specifically, the time point calculating part 41a extracts the program history information of a program displayed in the past at the same day and time as the current day and time from the DB of the first week to the DB of the (Y−1)th week. The (Y−1)th week represents the week one week before the current week (Y-th week).

The time point calculating part 41a calculates a time point TP(c) per reception-enabled channel with the use of one or more pieces of extracted program history information and a weighting factor. Hereinbelow, the time point TP(c) is merely referred to as TP(c) as well.

The later taste of a user is more likely to be reflected as closer to the current Y-th week. Accordingly, in this preferred embodiment, a value for calculating a point showing a larger value is set as the weighting factor as closer to the Y-th week.

For example, here, a program A whose genre is “information” is being broadcast on a channel 1 of a ground wave at the current time and date (at time T in the day D). The terrestrial tuner 11 is capable of receiving the program A on the channel 1 of the ground wave. In this case, the time point calculating part 41a calculates the TP (ground 1). “Ground 1” represents the channel 1 of a ground wave.

The TP (ground 1) is calculated as follows.

The time point calculating part 41a retrieves the DB (1, D, T) of the first week to the DB (Y−1, D, T) of the (Y−1)th week from the DB of the first week to the DB of the (Y−1)th week. For example, the DB (Y−1, D, T) is the program history information at the time T on the (Y−1)th week day D in the DB of the (Y−1)th week.

Here, (Y−1) is y, D is Monday, and T is the time at seven o'clock. In this case, DB (Y−1, D, T) is the information (program history information) of a cell indicating “w=ground, c=CH1, k=information”, which is specified by the column “Monday” and the row “t=7:00” of FIG. 2.

Then, the time point calculating part 41a extracts program history information corresponding to (w=ground, c=CH1, k=*) or (w=*, c=*, k=information) from the plurality of pieces of retrieved program history information. Note that “*” represents a wild card, that is, any information.

For example, the program history information corresponding to (w=ground, c=CH1, k=*) is the program history information showing “w=ground, c=CH1) in FIG. 2.

Here, the program history information corresponding to (w=ground, c=CH1, k=*) resides in the DBs of the (Y−1)th week, (Y−3)th week, and (Y−10)th week. The program history information corresponding to (w=*, c=*, k=information) resides in the DBs of the (Y−13)th week and (Y−14)th week. In this case, the time point TP (ground 1) is represented by Equation 1 below.

TP(ground 1)=a(Y−1)+a(Y−3)+a(Y−10)+b(Y−13)+b(Y−14) (Equation 1)

In Equation 1, a(y (y is a natural number)) is a function for weeks in which channels coincide with each other, b(y) is a function for weeks in which program genres coincide with each other, and an argument y in each of a(y) and b(y) is a value representing a week (for example, Y−1).

In this preferred embodiment, the values of a(y) and b(y) are set to be larger as the value of the argument y of each of a(y) and b(y) is closer to the current week (Y).

In the time point calculating process, the time point calculating part 41a calculates the point TP(c) corresponding to the current time for each of all reception-enabled channels over which each reception tuner is currently capable of receiving a program, similarly to the method using Equation 1 above. That is, the time point calculating part 41a calculates TP(c) per reception-enabled channel of the all reception-enabled channels and associates (assigns) the calculated TP(c) with (to) each of the reception-enabled channels.

In a case where a view pattern of a user haw been determined, it is highly likely that channels associated with TP(c) will be limited through the above-mentioned process. In this case, even if the time point calculating part 41a associates TP(c) with the channel frequently viewed (strongly favored) by a user, points are not associated with most channels.

The elements for associating a channel, which has not been associated with a point by the time point calculating part 41a, with a point from ordinary taste information of a user are elements below. That is, they are the channel point calculating part 41b, the genre point calculating part 41c, and the broadcast wave point calculating part 41d.

The above-mentioned parts refer to all pieces of program history information recorded in the history recording part 40 to calculate a point using the program history information corresponding to the taste of a user irrespective of time.

In the channel point calculating process in Step S212, a channel point UPc(c) is calculated using the DB recorded in the history recording part 40. Hereinbelow, the channel point UPc(c) is merely referred to as UPc(c) as well.

More specifically, the channel point calculating part 41b calculates UPc(c) per each of specific channels different from each other that are shown in the all pieces of program history information in the DB of the first week to the DB of the (Y−1)th week, and associates (assigns) the calculated UPc(c) with (to) each of the specific channels.

Specifically, the channel point calculating part 41b retrieves all pieces of program history information in the DB (1, *, *) of the first week to the DB (Y−1, *, *) of the (Y−1)th week recorded in the history recording part 40.

Next, the channel point calculating part 41b extracts the program history information showing a specific channel from the plurality of pieces of retrieved program history information of the respective DBs. Then, the channel point calculating part 41b calculates UPc(c) using the extracted one or more pieces of program history information and a function having a weighting factor similar to that of Equation 1. Then, the channel point calculating part 41b associates (assigns) the calculated UPc(c) with (to) the specific channel.

Here, the specific channel is the channel 1 (CH1) of a ground wave. In this case, the channel point calculating part 41b calculates UPc (ground 1). “Ground 1” represents the channel 1 of a ground wave.

UPc (ground 1) is calculated as follows.

The channel point calculating part 41b extracts the program history information corresponding to (w=ground, c=CH1, k=*) from the all pieces of retrieved program history information. For example, the program history information corresponding to (w=ground, c=CH1, k=*) is the program history information showing “w=ground, c=CH1” in FIG. 2.

Here, the program history information corresponding to (w=ground, c=CH1, k=*) resides in the DBs of the (Y−1)th week, (Y−4)th week, and (Y−11)th week. In this case, UPc (ground 1) is represented by Equation 2 below.

UPc(ground 1)=a(Y−1)+a(Y−4)+a(Y−11) (Equation 2)

The right side of Equation 2 is similar to the first half of the right side of Equation 1, and thus detailed description thereof is not given again.

By the method described above, the channel point calculating part 41b calculates UPc(c) per each of the specific channels different from each other that are shown in the all pieces of program history information in the DB of the first week to the DB of the (Y−1)th week, and associates (assigns) the calculated UPc(c) with (to) each of the specific channels.

In the genre point calculating process in Step S213, a genre point UPk(k) is calculated using the DB recorded in the history recording part 40. Hereinbelow, the genre point UPk(k) is merely referred to as UPk(k) as well.

More specifically, the genre point calculating part 41c calculates UPk(k) per each of specific genres different from each other that are shown in all pieces of program history information in the DB of the first week to the DB of the (Y−1)th week, and associates (assigns) the calculated UPk(k) with (to) each of the specific genres.

Specifically, the genre point calculating part 41c retrieves all pieces of program history information in the DB (1, *, *) of the first week to the DB (Y−1, *, *) of the (Y−1)th week recorded in the history recording part 40.

Next, the genre point calculating part 41c extracts the program history information showing a specific genre from a plurality of pieces of retrieved program history information of the DBs. Then, the genre point calculating part 41c calculates UPk(k) using the extracted one or more pieces of program history information and a function having a weighting factor similar to that of Equation 1. Then, the genre point calculating part 41c associates (assigns) the calculated UPk(k) with (to) the specific genre.

Here, the specific genre is “information”. In this case, the genre point calculating part 41c calculates UPk (information).

UPk (information) is calculated as follows.

The genre point calculating part 41c extracts the program history information corresponding to (w=*, c=*, k=information) from the all pieces of retrieved program history information. For example, the program history information corresponding to (w=*, c=*, k=information) is the program history information showing “k=information” in FIG. 2.

Here, the program history information corresponding to (w=*, c=*, k=information) resides in the DBs of the (Y−13)th week and (Y−14)th week. In this case, UPk (information) is represented by Equation 3 below.

UPk(information)=b(Y−13)+b(Y−14) (Equation 3)

The right side of Equation 3 is similar to the second half of the right side of Equation 1, and thus detailed description thereof is not given again.

By the method described above, the genre point calculating part 41c calculates UPk(k) per each of the specific genres different from each other that are shown in the all pieces of program history information in the DB of the first week to the DB of the (Y−1)th week, and associates (assigns) the calculated UPk(k) with (to) each of the specific genres.

In the broadcast wave point calculating process in Step S214, a broadcast wave point UPw(w) is calculated using the DB recorded in the history recording part 40. Hereinbelow, the broadcast wave point UPw(w) is merely referred to as UPw(w) as well.

More specifically, the broadcast wave point calculating part 41d calculates UPw(w) per each of specific broadcast waves different from each other that are shown in all pieces of program history information in the DB of the first week to the DB of the (Y−1)th week, and associates (assigns) the calculated UPw(w) with (to) each of the specific broadcast waves.

Specifically, the broadcast wave point calculating part 41d retrieves all pieces of program history information in the DB (1, *, *) of the first week to the DB (Y−1, *, *) of the (Y−1)th week recorded in the history recording part 40.

Next, the broadcast wave point calculating part 41d extracts the program history information showing a specific broadcast wave from a plurality of pieces of retrieved program history information of the DBs. Then, the broadcast wave point calculating part 41d calculates UPw(w) using the extracted one or more pieces of program history information and a function having a weighting factor similar to that of Equation 1.

Here, the specific broadcast wave is a ground wave. In this case, the broadcast wave point calculating part 41d calculates UPw (ground). “Ground” of UPw (ground) refers to a ground wave.

UPw (ground) is calculated as follows.

The broadcast wave point calculating part 41d extracts the program history information corresponding to (w=ground, c=*, k=*) from the all pieces of retrieved program history information. For example, the program history information corresponding to (w=ground, c=*, k=*) is the program history information showing “w=ground” in FIG. 2.

Here, the program history information corresponding to (w=ground, c=*, k=*) resides in the DBs of the (Y−13)th week and (Y−14)th week. In this case, UPw (ground) is represented by Equation 4 below.

UPw(ground)=c(Y−13)+c(Y−14) (Equation 4)

In Equation 4, c(y (y is a natural number)) is a function for weeks in which broadcast waves coincide with each other, and an argument y in c(y) is a value showing a week (for example, Y−13). In this preferred embodiment, the value of c(y) is set to be larger as the value of the argument y of c(y) is closer to the current week (Y).

By the method described above, the broadcast wave point calculating part 41d calculates UPw(w) per each of the specific broadcast waves different from each other that are shown in all pieces of program history information in the DB of the first week to the DB of the (Y−1)th week, and associates (assigns) the calculated UPw(w) with (to) each of the specific broadcast waves.

In the point calculating process in Step S215, the point P(c) is calculated. A larger value is set to the point P(c) along with an increasing possibility (probability) of a channel of the program most likely to be favored by a user in the current time frame, in accordance with the past view history (program history information). The point P(c) shows a larger value as a channel corresponds more to the past view history (program history information) of the user and the taste of the user. Hereinbelow, the point P(c) is merely referred to as P(c) as well.

In the point calculating process, the information organizing part 41 calculates P(c) for each of the all reception-enabled channels using the all time points TP(c), channel points UPc(c), and genre points UPk(k) which have been calculated in Steps S211 to S214.

Then, the information organizing part 41 associates (assigns) the calculated P(c) with (to) each of the reception-enabled channels.

P(c) is calculated by Equation 5 below.

P(c)=1×TP(c)+m×UPc(c)+n×UPk(k)+p×UPw(w) (Equation 5)

In Equation 5, 1, m, n, and p are weighting factors of UPw(w) of TP(c), UPc(c), UPk(k), and UPw(w), respectively. TP(c) of Equation 5 is calculated using the time t that changes with a lapse of time. Therefore, TP(c) changes with a lapse of time. Also, UPk(k) to be referred to changes if the genre of a program being currently broadcast changes. Therefore, the value of P(c) changes in real time.

For example, here, the program A whose genre is “information” is broadcast on the channel 1 of a ground wave. Also, the terrestrial tuner 11 is capable of receiving the program A over the channel 1 of a ground wave.

In this case, the point P (ground 1) on the channel 1 of a ground wave is calculated. “Ground 1” refers to the channel 1 of a ground wave. P (ground 1) is represented by Equation 6 below.

P(ground 1)=1×TP(ground 1)+m×UPc(ground 1)+n×UPk(information)+p×UPw(ground) (Equation 6)

In the sorting process in Step S220, the information organizing part 41 sorts the reception-enabled channels corresponding to the time points P(c) calculated in Step S215 in a descending order of values of the time points P(c).

The sorting process is not limited to the above, and the information organizing part 41 may sort the reception-enabled channels corresponding to the time points P(c) calculated in Step S215 in an ascending order of values of the time points P(c). That is, the information organizing part 41 (point calculating part) sorts the reception-enabled channels corresponding to calculated points P(c), over which the programs can be received, in a descending order or ascending order of values of the points P(c).

Then, the information organizing part 41 sets, as a user favorite channel, a reception-enabled channel corresponding to the point P(c) having the largest value among the plurality of calculated points P(c). The user favorite channel is a channel most likely to be selected by the user using, for example, the remote controller 200 at least at power-on of the television receiver 100. That is, the user favorite channel is a channel most strongly favored by a user at power-on of the television receiver 100. The timing of the user favorite channel is not limited to power-on, and the user favorite channel may be a channel that most corresponding to the taste of the user.

Then, the selection instructing part 42 selects a reception-enabled channel (user favorite channel) corresponding to the point P(c) having the largest value among the plurality of sorted reception-enabled channels. Then, the selection instructing part 42 sends a selection instruction for selecting the user favorite channel to the selection part 14.

As described above, the information organizing part 41 calculates points for all channels over which the programs can be received currently and sorts the channels corresponding to the points in a descending order of values of the points.

Then, the selection instructing part 42 sends, to the selection part 14, a selection instruction for selecting a channel (user favorite channel) corresponding to the point having the largest value.

The process of sending a selection instruction may be performed by the information organizing part 41 in place of the selection instructing part 42. In this case, the television receiver 100 is not required to include the selection instructing part 42.

In the channel selecting process in Step S230, the selection part 14 selects the user favorite channel in accordance with the received selection instruction. That is, the selection part 14 selects the channel corresponding to the point having the largest value that has been calculated by the information organizing part 41 (point calculating part). Accordingly, the television receiver 100 is activated in the state in which the user favorite channel is selected.

Then, the display part 60 displays the program of the selected user favorite channel. The selection process is ended through the above.

As described above, the selection process is performed at power-on. “At power-on” refers to the period in which the operation mode of the television receiver 100 is shifted from the standby mode to the normal mode, as described above.

Here, power is turned on through the operation of the power button 50 of the remote controller 200 or the operation of a power button provided in the television receiver 100. In this case, as a result of the selection process, the selection part 14 selects the user favorite channel among the all channels over which the television receiver 100 is capable of receiving programs at power-on of the television receiver 100, based on each piece of program history information. Then, the display part 60 displays the program of the selected user favorite channel.

That is, a program of a channel most likely to be selected by a user at power-on is displayed. Therefore, the television receiver 100 according to this preferred embodiment is capable of promptly selecting a channel desired by a user at power-on. This improves the operability of the television receiver 100 such that a user whose taste is clear is only required to perform an intuitive operation. Therefore, ease-of-use is improved for a user.

When a user turns on the power of the television receiver 100, video images (program) are displayed in the state in which a channel matching the point having the largest value is selected and the channel of the program corresponding to the view pattern of the user is selected (channel selection) through the channel selection process. As a result, the user views a program matching the view pattern, and accordingly, in a case where the power of the television receiver 100 is turned on, is capable of viewing a favorite program without changing a channel.

Through the above, the period of time from the power-on to the selection of a channel matching the taste of a user can be reduced efficiently by fewer and simpler operations compared with a conventional case.

Also when the power of the television receiver 100 is turned on using the power button 50 of the remote controller 200, the channel corresponding to the point having the largest value is selected in the channel selecting process (by the selection part 14) described above, so that the program of this channel is displayed.

That is, when the power of the television receiver 100 is turned on, the program of a channel strongly favored by a user is displayed first without recognition of the user. This reduces a burden of the operation in channel selection by the user.

As described above, according to this preferred embodiment, the period of time from power-on of the television receiver to the selection of a desired program performed by a user can be reduced efficiently by accumulating pieces of information of a user taste in simple databases.

If the time at which power is turned on is few minutes before the unit of time changes, such as 6:56, the selection instructing part 42 and the selection part 14 may perform the process for preferentially displaying a pre-selected program at the time of the next unit.

In viewing the television, a user performs an operation of selecting a program that the user views in a routine daily pattern more often than the operation of searching for or selecting new information or information of interest on television.

Therefore, in this preferred embodiment, a series of those operations can be selected instantaneously in the above-mentioned process. Also, the user favorite channel can be selected without recognition of a user himself/herself.

The television receiver 100 according to this preferred embodiment is premised on that a user selects a regular channel based on his/her taste. For example, the user selects a specific channel for viewing the same information program in the mornings. Alternatively, for example, the user selects a specific channel for viewing news in the evenings. Still alternatively, the user selects a specific channel for viewing a program such as drama, animation, or variety the user favors strongly in the nights, which is repeated every week.

(First Modification of First Preferred Embodiment)

A first modification of this preferred embodiment describes a process (hereinbelow, also referred to as channel switching process) in a case where a user performs an operation for selecting a program different from that of a channel selected at the activation of the television receiver 100.

The channel switching process is performed independently of another process.

Although detailed description is given below, in the channel switching process, the selection part 14 selects the reception-enabled channels sorted in the sorting process in one of an ascending order and a descending order of values of points corresponding to the reception-enabled channels every time the television receiver 100 receives a signal for sorting channels in an ascending order that is sent from the remote controller 200.

Also, the selection part 14 selects the reception-enabled channels sorted in the sorting process in the other of the ascending order and the descending order of values of points corresponding to the reception-enabled channels every time the television receiver 100 receives a signal for switching channels in a descending order that is sent from the remote controller 200.

Specific description is given below by taking an example.

Here, after the selection process is performed, a channel different from a channel of a program currently displayed by the display part 60 is selected. As an example, here, a user pressed down the descending selection button 51b of the remote controller 200.

In this case, the remote controller 200 sends a descending selection signal for switching channels in a descending order to the television receiver 100. Accordingly, the reception part 15 receives the descending selection signal.

When the reception part 15 receives the descending selection signal, the selection instructing part 42 selects a reception-enabled channel corresponding to P(c) showing the second smallest value to the value of P(c) corresponding to the channel currently selected among the plurality of reception-enabled channels sorted in the sorting process.

Here, the number of reception-enabled channels is three. Points showing “30”, “41”, and “50” are respectively associated with the three reception-enabled channels. The channel currently selected is the channel corresponding to the point showing 50. Also, the channel currently selected is a channel corresponding to a point showing 50. In this case, through the above-mentioned process, the selection instructing part 42 selects the reception-enabled channel corresponding to the point showing “41” which is the second smallest to “50”.

Then, the selection instructing part 42 sends a selection instruction for selecting the selected reception-enabled channel to the selection part 14. The selection part 14 selects a reception-enabled channel different from the channel currently selected, in accordance with the received selection instruction.

Then, the display part 60 displays a program of the selected reception-enabled channel.

Through the above, the channel switching process is ended.

The descending selection signal may be a signal for selecting a reception-enabled channel corresponding to P(c) showing the second largest value to the value of P(c) corresponding to the channel currently selected. In this case, when the reception part 15 receives the descending selection signal, the selection instructing part 42 selects the reception-enabled channel corresponding to P(c) showing the second largest value to the value of P(c) corresponding to the channel currently selected among the plurality of reception-enabled channels sorted in the sorting process. Then, the selection part 14 selects a reception-enabled channel different from the channel currently selected which has been selected by the selection instructing part 42.

As another example, a user pressed down the ascending selection button 51a of the remote controller 200.

In this case, the remote controller 200 sends the ascending selection signal for switching channels in an ascending order to the television receiver 100. Accordingly, the reception part 15 receives the ascending selection signal.

When the reception part 15 receives the ascending selection signal, the selection instructing part 42 selects a reception-enabled channel corresponding to P(c) showing the second largest value to the value of P(c) corresponding to the channel currently selected among the plurality of reception-enabled channels sorted in the sorting process.

Then, the selection instructing part 42 sends a selection instruction for selecting the selected reception-enabled channel to the selection part 14. The selection part 14 selects a reception-enabled channel different from the channel currently selected.

The ascending selection signal may be a signal for selecting a reception-enabled channel corresponding to P(c) showing the second smallest value to the value of P(c) corresponding to the channel currently selected. In this case, when the reception part 15 receives the ascending selection signal, the selection instructing part 42 selects the reception-enabled channel corresponding to P(c) showing the second smallest value to the value of P(c) corresponding to the channel currently selected among the plurality of reception-enabled channels sorted in the sorting process. Then, the selection part 14 selects a reception-enabled channel different from the channel currently selected which has been selected by the selection instructing part 42.

The ascending selection button 51a is pressed down as described above, which enables to search for a program of a channel corresponding to a point having a larger value, that is, a program favored more strongly.

Accordingly, even if the program of a channel that is currently displayed is a program that does not match the taste of a user, the user can reach a channel strongly favored at an early stage. That is, the user can select a channel strongly favored at an early stage.

According to the first modification of this preferred embodiment, in a case where a user presses down the ascending selection button 51a or the descending selection button 51b of the remote controller 200 for changing channels, channels sorted in the order of programs that are viewed more frequently are selected. As a result, a program more matching the taste of a user is displayed earlier, leading to improvements the ease-of-use for the user.

In a case where the ascending selection button 51a is pressed down in the state in which the channel of the point having the largest value is being selected, the display part 60 may display a message indicating the absence of a program that the user favors more. In this case, the channel to be selected may be a channel least favored by a user. That is, the selection of channels may loop.

(Second Modification of First Preferred Embodiment)

In the first preferred embodiment, after the selection of a channel in activation of the television receiver 100, the channel does not change in a case where the remote controller 200 or the like is not operated.

A second modification of this preferred embodiment describes a process (hereinbelow, also referred to as selection process A) for changing a channel with a lapse of time or with a change of genre of a program being broadcast.

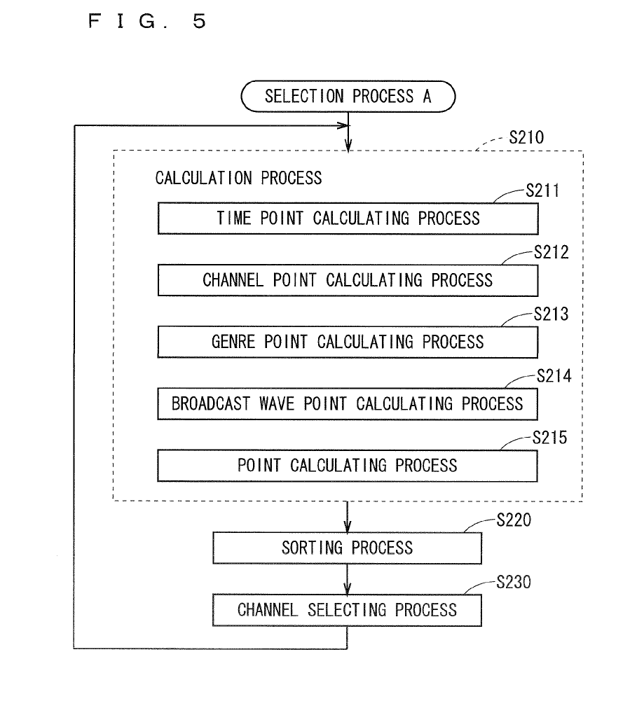

FIG. 5 is a flowchart of the selection process A. As to FIG. 5, similar processes to the processes described in the first preferred embodiment are performed in the processes of the same numbers as those of the step numbers in FIG. 4, and thus detailed description thereof is not given again.

The selection process A is different from the selection process of FIG. 4 in that the process of Step S210 is performed again after the process of Step S230. The other processes in the selection process A are similar to those of the selection process, and thus, detailed descriptions thereof are not repeated.

The selection process A is performed at power-on of the television receiver 100, similarly to the selection process.

Through the selection process A, Steps S210, S220, and S230 are repeatedly performed. Accordingly, the information organizing part 41 (point calculating part) repeatedly performs, using pieces of information of programs shown by pieces of program history information, a calculation process of calculating a point per channel such that among all channels over which programs can be received, a channel more likely to be selected by a user shows a larger value with a lapse of time after power-on of the television receiver 100.

Here, the reception part 15 received an ascending selection signal or descending selection signal from the remote controller 200 while the display part 60 has been displaying a program of a channel different from a channel selected by the selection part 14 at power-on of the television receiver 100.

In this case, Steps S210 to S230 are repeatedly performed, so that the selection part 14 selects a channel corresponding to the latest point having the largest value calculated in the calculation process. The display part 60 displays a program of the latest channel selected.

That is, while the television receiver 100 is displaying a program of a channel different from the channel selected by the selection part 14 at power-on, the selection part 14 selects a channel corresponding to the latest point having the largest value calculated in the calculation process in a case where the television receiver 100 receives a signal for switching channels in an ascending order or descending order from the remote controller 200.

The display part 60 (television receiver 100) displays a program of the selected channel corresponding to the latest point.

In the second modification of this preferred embodiment, the information organizing part 41 recalculates points in real time with a lapse of time or a change of genre of a program being broadcast even while a user is viewing a program. Then, the information organizing part 41 sorts the order of channels. The selection instructing part 42 and the selection part 14 select a channel corresponding to the latest point having the largest value among the sorted channels.

Accordingly, even if a user selected a channel (channel selection) different from a channel of the program that the user ordinarily views, a program of a channel corresponding to a point having the largest value recalculated is displayed when the user presses the ascending selection button 51a or the descending selection button 51b for performing zapping. Therefore, the user notices that a program that the user ordinarily views has started at an early stage and is capable of viewing the program through few operations. That is, even if the user has selected a channel of a program different from that of the program the user ordinarily views, the user notices a program that the user ordinarily views at an early stage in performing zapping, and thus is capable of viewing that program anew.

That is, in the second modification of this preferred embodiment, the information organizing part 41 sorts the priority of candidate channels in real time along with a lapse of time. Accordingly, a user views the program different from the program the user always views without noticing that the program the user ordinarily views has started.

In this case, when the user performs zapping of changing one channel after another using the ascending selection button 51a or the descending selection button 51b of the remote controller 200 for searching for another different program, programs that the user ordinarily views are displayed in the shortest period of time and in an intuitive manner. This recommends the user to select a program. The programs are displayed from one strongly favored by the user, which enables to promptly search for a program strongly favored by the user in zapping.

In other words, in the second modification of this preferred embodiment, the television receiver 100 stands by in the state of being capable of selecting a program strongly favored by the user in real time even while the user is viewing a program. As a result, when the user performs zapping of changing one channel after another using the ascending selection button 51a or the descending selection button 51b of the remote controller 200 for searching for another different program, for example, a program that the user forgets viewing though ordinarily views is displayed in the shortest period of time. This recommends a user to intuitively select a channel, leading to improvements in ease-of-use for the user.

(Third Modification of First Preferred Embodiment)

A third modification of this preferred embodiment describes a process (hereinbelow, also referred to as informing process) for displaying a message indicating that a program has started.

The informing process is performed independently of another process.

In the third modification of this preferred embodiment, the selection process A and the informing process are performed in parallel.

As described in the second modification of the first preferred embodiment, Steps S210, S220, and S230 are repeatedly performed through the selection process A. Accordingly, the information organizing part 41 (point calculating part) repeatedly performs the calculation process.

The selection part 14 selects a channel corresponding to the latest point having the largest value calculated in the calculation process.

In the informing process, in a case where the selection part 14 does not select a channel corresponding to a point showing a value larger than a predetermined threshold after the calculation process has been repeatedly performed, the display part 60 displays a message indicating that a program of a channel corresponding to a point showing the value larger than the threshold for a certain period.

Specifically, in the informing process, the control part 20 judges whether or not the selection instructing part 42 selects a channel corresponding to a point showing a value larger than a predetermined threshold as the need arises. The program of a channel corresponding to a point showing a value larger than a predetermined threshold is, for example, a program that the user usually views.

In a case where the selection instructing part 42 (selection part 14) does not select a channel corresponding to the point showing a value larger than the predetermined threshold, the control part 20 performs control for causing the display part 60 to display a message M for a certain period. The message M is, for example, a message saying “a program in which you are more interested than a current program has started on a channel X”. A certain period is, for example, 20 seconds. The informing process is ended through the above.

In a case where the channel corresponding to the point having the largest value, which is expected to be selected by the selection part 14 through the calculation process, differs from the channel currently selected (channel selection) by the selection part 14 (selection instructing part 42) as a result of the above-mentioned informing process, the display part 60 performs the following display. The display part 60 displays information of the channel corresponding to the point having the largest value, which is selected by the selection instructing part 42, for a certain period and provides a user with taste information.

Through the process above, for example, a user can reach the channel by pressing the descending selection button 51b only once.

That is, in the third modification of this preferred embodiment, in a case where a program that a user always views (program of the channel corresponding to the latest point having the largest value) has started, a message saying that the program has started is displayed for several seconds. As a result, a user is notified of forgetting to view the program that the user strongly favors, whereby the user recognizes the above.

In other words, according to the process of the third modification of this preferred embodiment, in a case where there is a program that a user forgets to view though views frequently and ordinarily even while viewing another program, the information can be provided to the user by displaying a message saying that the program has started.

Through the above, in the third modification of this preferred embodiment, the information indicating that a program expected based on the taste information has started can be provided to the user even if the user has selected a channel of a program different from the program that the user ordinarily views.

In a case where a user views a program of a channel different from that of the program the user always views, the process for informing that a program that the user strongly favors will start may be performed by displaying a message indicating that the program that the user favors more strongly than the current program for several seconds.

### Other Modifications

While the television receiver according to the present invention has been described with reference to the preferred embodiment, the present invention is not limited thereto. The present invention includes the modification conceived by those skilled in the art in this preferred embodiment within the scope of the present invention. That is, in the present invention, the preferred embodiment and the variations of the preferred embodiment may be freely combined with each other or may be appropriately modified or omitted within the scope of the present invention.

The television receiver 100 may not include the all elements shown in FIG. 1. That is, it suffices that the television receiver 100 includes only a minimum number of elements required for achieving the effects of the present invention. For example, the television receiver 100 may be configured to include only the history recording part 40 and the selection part 14.

The present invention may be implemented as the channel selection method in which the operations of the characteristic constituent parts included in the television receiver 100 are steps. The present invention may be implemented as the program for causing a computer to execute each step included in the channel selection method as described above. The present invention may be implemented as a computer-readable recording medium which stores such a program. This program may be distributed through a transmission medium such as the Internet.

All numeric values used in the preferred embodiment above are numeric values in an example for specifically describing the present invention. That is, the present invention is not limited to the numeric values used in the preferred embodiment above.

The channel selection method according to the present invention corresponds to a part or all of the process of FIG. 3 and the selection process of FIG. 4. The channel selection method according to the present invention is not necessarily required to include the all corresponding steps. That is, it suffices that the channel selection method according to the present invention includes only a minimum number of steps for achieving the effects of the present invention. For example, the channel selection method according to the present invention may include only Step S110 of FIG. 3 and Step S230 of FIG. 4.

The sequence of executing steps in the channel selection method is an example for specifically describing the present invention and may be the sequence other than the above-mentioned one. A part of the steps in the channel selection method and the other step may be executed in parallel with and independently of each other.

A part of elements of the television receiver 100 may be implemented as large scale integration (LSI) that is typically an integrated circuit. For example, the selection part 14, the control part 20, the history recording part 40, the information organizing part 41, and the selection instructing part 42 may be implemented as an integrated circuit.

In the present invention, the preferred embodiment and the variations of the preferred embodiment may be freely combined with each other or may be appropriately modified or omitted within the scope of the present invention.

The present invention can be used as a television receiver capable of promptly selecting a channel desired by a user.

While the invention has been shown and described in detail, the foregoing description is in all aspects illustrative and not restrictive. It is therefore understood that numerous modifications and variations can be devised without departing from the scope of the invention.

What is claimed is:

1. A television receiver displaying a program consisting of video images, comprising:
a history recording part recording pieces of program history information respectively indicating pieces of information of a plurality of programs in a past predetermined period, the plurality of programs having been displayed by said television receiver; and
a selection part selecting, at power-on of said television receiver, a channel most likely to be selected by a user among all channels over which said television receiver is allowed to receive programs, based on said pieces of program history information.

2. The television receiver according to claim 1,
further comprising a point calculating part calculating, using the pieces of information of said programs respectively indicated by said pieces of program history information, a point per each of the all channels over which said programs are allowed to be received such that, among said all channels, a channel more likely to be selected by said user at least at said power-on shows a larger value,
wherein said selection part selects a channel corresponding to a point having a largest value calculated by said point calculating part.

3. The television receiver according to claim 2, wherein
said television receiver is controlled by a remote controller operated by said user,
said point calculating part sorts reception-enabled channels being channels over which programs are allowed to be received in a descending order or an ascending order of values of said points calculated, said channels corresponding to said points, and
said selection part:
(a) selects said sorted reception-enabled channels in one of an ascending order and a descending order of values of the points corresponding to said reception-enabled channels every time said television receiver receives a signal for switching the channels in an ascending order, the signal being sent from said remote controller; and
(b) selects said sorted reception-enabled channels in the other of the descending order and the ascending order of values of the points corresponding to said reception-enabled channels every time said television receiver receives a signal for switching the channels in a descending order, the signal being sent from said remote controller.

4. The television receiver according to claim 3, wherein
said point calculating part repeatedly performs, using the pieces of information of said programs indicated by said pieces of program history information, a calculation process of calculating a point per each of the all channels over which said programs are allowed to be received such that a channel more likely to be selected by said user among said all channels shows a larger value with a lapse of time after said power-on,
said selection part selects, in a case where said television receiver displays a program of a channel different from the channel selected by said selection part at said power-on, a channel that is calculated in said calculation process and corresponds to the latest point having a largest value upon said television receiver receiving the signal for switching channels in an ascending order or a descending order from said remote controller, and
said television receiver displays a program of said selected channel corresponding to said latest point.

5. The television receiver according to claim 4, further comprising
a display part displaying, in a case where said selection part does not select a channel corresponding to a point showing a value larger than a predetermined threshold after said calculation process is repeatedly performed, a message indicating that a program of the channel corresponding to the point showing the value larger than said threshold has started for a certain period.

6. A channel selection method performed by a television receiver displaying a program consisting of video images, the method comprising the steps of:
recording pieces of program history information respectively indicating pieces of information of a plurality of programs in a past predetermined period displayed by said television receiver; and
selecting, at power-on of said television receiver, a channel most likely to be selected by a user among all channels over which said television receiver is allowed to receive programs, based on said pieces of program history information.
